(19) United States
(12) Patent Application Publication
(10) Pub. No.: US 2008/0045665 A1
(43) Pub. Date: Feb. 21, 2008

(54) THERMOPLASTIC ELASTOMER AND THERMOPLASTIC ELASTOMER COMPOSITION

(75) Inventor: Keisuke Chino, Kanagawa (JP)

Correspondence Address: CONNOLLY BOVE LODGE & HUTZ LLP, 1875 EYE STREET, N.W., SUITE 1100, WASHINGTON, DC, 20036, US

(73) Assignee: The Yokohama Rubber Co., Ltd., Tokyo (JP)

(21) Appl. No.: 11/740,577

(22) Filed: Apr. 26, 2007

(30) Foreign Application Priority Data
Apr. 27, 2006 (JP) 2006-123706

(51) Int. Cl. C08F 120/02

(52) U.S. Cl. 525/329.7; 525/329.4; 525/374; 525/382

(57) ABSTRACT

A thermoplastic elastomer obtained by reacting an elastomeric polymer containing a cyclic acid anhydride group in its side chain and a polyamine compound having two or more primary amino groups, and a thermoplastic elastomer composition containing the thermoplastic elastomer are provided. The thermoplastic elastomer exhibits excellent physical properties such as mechanical strength and in particular tensile strength while retaining its excellent recyclability.

The entire content of a document cited in this specification is incorporated herein by reference.

BACKGROUND OF THE INVENTION

This invention relates to a thermoplastic elastomer and a thermoplastic elastomer composition, and more specifically, to a thermoplastic elastomer which has the characteristic of repetitively and reproducibly undergoing crosslinking and de-crosslinking by temperature change (hereinafter sometimes referred to simply as “recyclability”), and a thermoplastic elastomer composition containing such thermoplastic elastomer. The invention particularly relates to a thermoplastic elastomer composition exhibiting excellent resistance to compression set while retaining its excellent recyclability.

Recycling of once used materials is an urgent agenda in these days for environmental protection, resources saving, and other considerations. A crosslinked rubber (vulcanized rubber) has a stable three-dimensional network structure formed by covalent bonding of a macromolecular substance and a crosslinking agent (vulcanizing agent), and accordingly exhibits very high strength. Re-molding of such material, however, is difficult due to the crosslinking by the strong covalent bonding. On the other hand, thermoplastic elastomers utilize physical crosslinking, and molding of such material is readily accomplished by heat melting without the necessity of complicated vulcanization and molding steps including preforming.

A typical known example of such thermoplastic elastomer is a thermoplastic elastomer which contains a resin component and a rubber component, and in which the microcrystalline resin component constitutes a hard segment acting as the crosslink moiety for the three-dimensional network structure thereby preventing plastic deformation of the rubber component (soft segment) at room temperature, and softens or melts at an elevated temperature thus causing plastic deformation of the elastomer. Such thermoplastic elastomer containing the resin component, however, often suffers from the loss of rubber elasticity, and therefore, a material which is free from such resin component and to which thermoplasticity can be imparted is highly demanded.

In view of such situation, the inventor of the present invention has already found that a thermoplastic elastomer which is crosslinkable by hydrogen bond and which includes an elastomeric polymer having a carbonyl-containing group and a heterocyclic amine-containing group in its side chain can repetitively undergo crosslinking and de-crosslinking by changing temperature through the use of the hydrogen bond. Based on such finding, the inventor proposed a thermoplastic elastomer which is crosslinkable by hydrogen bond and which includes an elastomeric polymer having (i) a carbonyl-containing group and (ii) a heterocyclic amine-containing group in its side chain; and a method for the production of such thermoplastic elastomer which involves reacting an elastomeric polymer having a cyclic acid anhydride group in its side chain and a heterocyclic amine-containing compound at a temperature allowing the heterocyclic amine-containing compound to be chemically bonded to the cyclic acid anhydride group to thereby produce the thermoplastic elastomer (see, for example, JP 2000-169527 A).

The thermoplastic elastomer having such properties has enormous industrial and environmental values, and such material is also expected as a material having higher tensile strength and excellent recyclability without change in its physical properties even after repetitive crosslinking and de-crosslinking.

### SUMMARY OF THE INVENTION

However, the thermoplastic elastomer described in JP 2000-169527 A was often insufficient in the mechanical strength requisite for a composition, and in particular, in the resistance to compression set when released after having been compressed for a predetermined period of time, even if the thermoplastic elastomer includes a filler and other additives.

In view of the situation as described above, an object of the present invention is to provide a thermoplastic elastomer which exhibits excellent mechanical strength, and in particular, excellent resistance to compression set while retaining its excellent recyclability. Another object of the present invention is to provide a thermoplastic elastomer composition containing the thermoplastic elastomer described above.

The inventor of the present invention has made an intensive study to overcome the aforementioned problems, and as a result found that a thermoplastic elastomer obtained by a predetermined reaction exhibits excellent physical properties such as mechanical strength and in particular tensile strength while retaining the excellent recyclability. The present invention has been achieved on the basis of such finding. Accordingly, the present invention provides the thermoplastic elastomer and the thermoplastic elastomer composition described in the following (i) to (xiii).

(i) A thermoplastic elastomer obtained by reacting an elastomeric polymer containing a cyclic acid anhydride group in its side chain and a polyamine compound having two or more primary amino groups (—NH₂).

(ii) The thermoplastic elastomer according to (i) above, wherein the polyamine compound has secondary amino group (—NH—).

(iii) The thermoplastic elastomer according to (ii) above, wherein the polyamine compound is a polyalkyleneimine.

(iv) The thermoplastic elastomer according to any one of (i) to (iii) above, wherein the polyamine compound has branched carbon and/or branched nitrogen.

(v) The thermoplastic elastomer according to (iv) above, wherein the polyamine compound has tertiary amino group, that is, a group represented by the following formula:

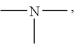

(vi) The thermoplastic elastomer according to any one of (i) to (v) above, wherein the polyamine compound also has two or more hydroxy groups.

(vii) The thermoplastic elastomer according to any one of (i) to (vi) above which has a structure represented by the following formula (1):

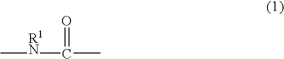

wherein R¹ is a hydrogen atom or a hydrocarbon group which may contain at least one heteroatom selected from the group consisting of O, N and S.

(viii) The thermoplastic elastomer according to (vii) above which has a structure represented by the following formula (2):

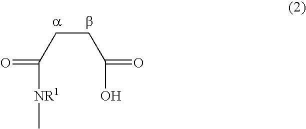

wherein R¹ is a hydrogen atom or a hydrocarbon group which may contain at least one heteroatom selected from the group consisting of O, N and S, the structure being attached to its main chain at α or β position.

(ix) The thermoplastic elastomer according to any one of (i) to (viii) above which is formed by reacting the elastomeric polymer with the polyamine compound and a polyol compound.

(x) The thermoplastic elastomer according to (ix) above, wherein the polyol compound is a polyether polyol.

(xi) The thermoplastic elastomer according to (ix) or (x) which has a structure represented by the following formula (3):

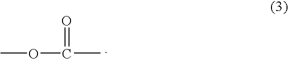

(xii) The thermoplastic elastomer according to (xi) above which has a structure represented by the following formula (4):

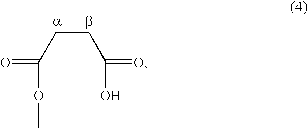

the structure being attached to its main chain at α or β position.

(xiii) A thermoplastic elastomer composition containing the thermoplastic elastomer according to any one of (i) to (xii) above.

The thermoplastic elastomer provided in the present invention exhibits excellent mechanical strength, and in particular, excellent resistance to compression set while retaining its excellent recyclability and is therefore useful. The composition containing the thermoplastic elastomer also exhibits the same effects and is extremely valuable, and is therefore very useful.

### DETAILED DESCRIPTION OF THE INVENTION

Next, the present invention is described in detail.

The thermoplastic elastomer according to a first aspect of the present invention (hereinafter also referred to simply as the “thermoplastic elastomer of the present invention”) is a thermoplastic elastomer obtained by reacting an elastomeric polymer containing a cyclic acid anhydride group in its side chain and a polyamine compound having two or more primary amino groups.

Although the reason why the thermoplastic elastomer of the present invention exhibits excellent mechanical strength, and in particular, excellent resistance to compression set while retaining its excellent recyclability is not clearly known, the inventor of the present invention believes as follows: The thermoplastic elastomer has in its structure a hydrogen bonding crosslink site (more specifically nitrogen atom of the amide bond generated by the reaction and hydroxy group generated by the reaction) and a covalent crosslink moiety (more specifically amide bond generated by the reaction) which are both formed by the reaction between the elastomeric polymer containing a cyclic acid anhydride group in its side chain and the polyamine compound having two or more primary amino groups, and hence such crosslink site and moiety could act as strong crosslink points.

Next, the elastomeric polymer containing a cyclic acid anhydride group in its side chain and the polyamine compound which are both used to produce the thermoplastic elastomer of the present invention are described in detail.

### (Elastomeric Polymer Containing a Cyclic Acid Anhydride Group in its Side Chain)

The elastomeric polymer containing a cyclic acid anhydride group in its side chain is an elastomeric polymer in which the cyclic acid anhydride group forms a chemically stable bond (covalent bond) with an atom constituting the main chain of the elastomeric polymer, and such “elastomeric polymer containing a cyclic acid anhydride group in its side chain” is produced by reacting the elastomeric polymer to be described below with a compound capable of introducing the cyclic acid anhydride group.

### (Elastomeric Polymer)

The elastomeric polymer is generally a known natural or synthetic polymer and is not subject to any particular limitation as long as it is a polymer having a glass transition point of up to room temperature (25° C.), namely, an elastomer.

Specific examples of the elastomeric polymer include diene rubbers such as natural rubber (NR), isoprene rubber (IR), butadiene rubber (SBR), 1,2-butadiene rubber, styrene-butadiene rubber (SBR), acrylonitrile-butadiene rubber (NBR), chloroprene rubber (CR), butyl rubber (IIR), ethylene-propylene-diene rubber (EPDM), and their hydrogenated products; olefin rubbers such as ethylene-propylene rubber (EPM), ethylene-acrylic rubber (AEM), ethylene-butene rubber (EBM), chlorosulfonated polyethylene, acrylic rubber, fluororubber, polyethylene rubber, and polypropylene rubber; epichlorohydrin rubbers; polysulfide rubbers; silicone rubbers; and urethane rubbers.

The elastomeric polymer as mentioned above may be an elastomeric polymer containing a resin component. Specific examples thereof include optionally hydrogenated polystyrene elastomeric polymers (for example, SBS, SIS, and SEBS), polyolefin elastomeric polymers, polyvinyl chloride elastomeric polymers, polyurethane elastomeric polymers, polyester elastomeric polymers, and polyamide elastomeric polymers.

The elastomeric polymer as mentioned above may be either liquid or solid and its molecular weight is not particularly limited. These factors may be selected as appropriate for the application of the thermoplastic elastomer in the first aspect of the present invention and the thermoplastic elastomer composition in a second aspect of the present invention (hereinafter referred to simply as the “composition of the present invention”) and the physical properties desired therefor.

When weight is given to fluidity of the thermoplastic elastomer and composition of the present invention (hereinafter also referred to simply as the “thermoplastic elastomer (composition) of the present invention”) under heating (de-crosslinking), the elastomeric polymer is preferably liquid, and in the case of diene rubber such as isoprene rubber or butadiene rubber, the weight average molecular weight, is preferably in the range of 1,000 to 100,000, and more preferably about 1,000 to 50,000.

On the other hand, when weight is given to strength of the thermoplastic elastomer (composition) of the present invention, the elastomeric polymer is preferably solid, and in the case of diene rubber such as isoprene rubber or butadiene rubber, the weight average molecular weight is preferably at least 100,000, and more preferably about 500,000 to 1,500,000.

In the present invention, the weight average molecular weight is measured by gel permeation chromatography (GPC) on a polystyrene basis. The solvent preferably used in the measurement is tetrahydrofuran (THF).

In the present invention, a mixture of two or more of the elastomeric polymers as mentioned above may be used. In such a case, the mixing ratio of the elastomeric polymers may be adequately selected depending on the application of the thermoplastic elastomer (composition) of the present invention, and physical properties and other factors required for the thermoplastic elastomer (composition) of the present invention.

The glass transition point of the elastomeric polymer is preferably up to 25° C. as described above, and when the elastomeric polymer has two or more glass transition points or when a mixture of two or more elastomeric polymers is used, at least one of the glass transition points is preferably up to 25° C. An article molded from the thermoplastic elastomer (composition) of the present invention will exhibit rubber elasticity at room temperature when the glass transition point of the elastomeric polymer is within the range, so this range is preferable.

In the present invention, the glass transition point is the one measured by DSC (differential scanning calorimetry). The temperature elevation rate is preferably 10° C./min.

Such elastomeric polymer is preferably a diene rubber such as natural rubber (NR), isoprene rubber (IR), butadiene rubber (BR), 1,2-butadiene rubber, styrene-butadiene rubber (SBR), ethylene-propylene-diene rubber (EPDM), or butyl rubber (IIR); or an olefin rubber such as ethylene-propylene rubber (EPM), ethylene-acrylic rubber (AEM), or ethylene-butene rubber (EBM), since such rubber has a glass transition point of up to 25° C. and an article molded from the thermoplastic elastomer (composition) of the present invention exhibits rubber elasticity at room temperature. When an olefin rubber is employed, the resulting thermoplastic elastomer (composition) of the present invention has an improved tensile strength when crosslinked, while the composition is less deteriorated due to absence of double bond.

In the present invention, the amount of styrene bonded in the styrene-butadiene rubber (SBR), and the degree of hydrogenation in the hydrogenated elastomeric polymer are not particularly limited, and such parameters may be adequately adjusted depending on the application of the thermoplastic elastomer (composition) of the present invention, and physical properties and other factors required for the thermoplastic elastomer (composition) of the present invention.

When the main chain of the elastomeric polymer is ethylene-propylene-diene rubber (EPDM), ethylene-acrylic rubber (AEM), ethylene-propylene rubber (EPM), or ethylene-butene rubber (EBM), the ethylene content is preferably 10 to 90 mol %, and more preferably 40 to 90 mol %. When the ethylene content is within the ranges, the resulting thermoplastic elastomer (composition) will exhibit satisfactory resistance to compression set and mechanical strength, particularly tensile strength and is therefore preferable.

Compound Capable of Introducing the Cyclic Acid Anhydride Group)

Exemplary compounds capable of introducing the cyclic acid anhydride group include cyclic acid anhydrides such as succinic anhydride, maleic anhydride, glutaric anhydride, and phthalic anhydride.

The elastomeric polymer having a cyclic acid anhydride group in its side chain may be produced by a commonly used method, for example, by graft polymerizing a cyclic acid anhydride onto the elastomeric polymer under such commonly used conditions as stirring with heating. Alternatively, a commercially available product may be used for the elastomeric polymer.

Examples of the commercially available product include maleic anhydride-modified isoprene rubbers such as LIR-403 (manufactured by Kuraray Co., Ltd.) and LIR-410A (prototype manufactured by Kuraray Co., Ltd.); modified isoprene rubbers such as LIR-410 (manufactured by Kuraray Co., Ltd.); carboxy-modified nitrile rubbers such as Krynac 110, 221, and 231 (manufactured by Polysar); maleic anhydride-modified polybutenes such as Nisseki Polybutene (manufactured by Nippon Oil Corporation); ethylene-methacrylic acid copolymers such as Nucrel (manufactured by Du Pont-Mitsui Polychemicals Co., Ltd.); ethylene-methacrylic acid copolymers such as Yukalon (manufactured by Mitsubishi Chemical Corporation); maleic anhydride-modified ethylene-propylene rubbers such as TAFMER M (for example, MA8510 manufactured by Mitsui Chemicals, Inc.); maleic anhydride-modified ethylene-butene rubbers such as TAFMER M (for example, MH7020 manufactured by Mitsui Chemicals, Inc.); maleic anhydride-modified polyethylenes such as ADTEX series (maleic anhydride-modified EVA and maleic anhydride-modified EMA manufactured by Japan Polyolefins Co., Ltd.), HPR series (maleic anhydride-modified EEA and maleic anhydride-modified EVA manufactured by Du Pont-Mitsui Polychemicals Co., Ltd.), Dumilan series (maleic anhydride-modified EVOH manufactured by Takeda Pharmaceutical Co., Ltd.), BONDINE (maleic anhydride-modified EEA manufactured by ATOFINA), Tuftec (maleic anhydride-modified SEBS, M1943 manufactured by Asahi Kasei Corporation), KRATON (maleic anhydride-modified SEBS, FG1901X manufactured by Kraton Polymers), Tufprene (maleic anhydride-modified SBS, 912 manufactured by Asahi Kasei Corporation), SEPTON (maleic anhydride-modified SEPS (manufactured by Kuraray Co., Ltd.), REXPEARL (maleic anhydride-modified EEA, ET-182G, 224M, 234M manufactured by Japan Polyolefins Co., Ltd.), and Auroren (maleic anhydride-modified EEA, 200S, 250S manufactured by Nippon Paper Chemicals Co., LTD.); and maleic anhydride-modified polypropylenes such as Admer (for example, QB550, LF128 manufactured by Mitsui Chemicals, Inc.); ethylene-glycidyl methacrylate-vinyl acetate copolymers and ethylene-glycidyl methacrylate-methyl acrylate copolymers such as Bondfast series (manufactured by Sumitomo Chemical Co., Ltd.).

### (Polyamine Compound)

The polyamine compound is not subject to any particular limitation as long as it is a compound having two or more primary amino groups. Examples of the polyamine compound include polyalkyleneimines such as polyethyleneimine and polypropyleneimine; aliphatic polyamines such as methylenediamine, ethylenediamine, propylenediamine, 1,2-diaminopropane, 1,3-diaminopentane, hexamethylenediamine, diaminoheptane, diaminododecane, diethylenetriamine, diethylaminopropylamine, N-aminoethylpiperazine and triethylenetetramine; alicyclic amines such as diaminocyclohexane and bis-(4-aminocyclohexyl)methane; and aromatic polyamines such as diaminotoluene, diaminoxylene, tetramethylxylylenediamine, metaphenylenediamine, diaminodiphenylmethane, and diaminodiphenylsulfone.

In the present invention, it is preferable for the polyamine compound to further contain secondary amino group. More specifically, polyalkyleneimine is preferable. When the polyamine compound has secondary amino group, the secondary amino group can form a hydrogen bond with carboxylic acid or the like, thus further enhancing the mechanical strength.

The secondary amino group as used herein refers to imino group (—NH—).

Specific examples of the polyalkyleneimine that may be preferably used include diethylenetriamine and triethylenetetramine.

In the present invention, the polyamine compound preferably has branched carbon and/or branched nitrogen, and more preferably tertiary amino group. When included in the polyamine compound, the branched carbon and/or branched nitrogen reacts with the above-mentioned elastomeric polymer containing a cyclic acid anhydride group in its side chain to yield a thermoplastic elastomer having an increased number of hydrogen bonding crosslink sites, and three-dimensional intermolecular crosslinking takes place to improve the mechanical strength and, in particular resistance to compression set.

The terms “branched carbon” and “branched nitrogen” as used herein refer to a carbon atom at a position where the main chain skeleton of the polyamine compound is branched, and a nitrogen atom at a position where the main chain skeleton of the polyamine compound is branched, respectively. The term “tertiary amino group” refers to a nitrogen atom-containing group to which no hydrogen atom is attached.

Of those polyamine compounds, polyethyleneimine is preferred, because it has two or more primary amino groups as well as one or more secondary amino groups and one or more tertiary amino groups.

The “polyethyleneimine” as used herein refers to a compound which contains primary, secondary and tertiary amino groups at a ratio of approximately 1:2:1 and has a weight average molecular weight of about 300 to 100,000. To be specific, the polyethyleneimine is, for example, a compound represented by the following general formula:

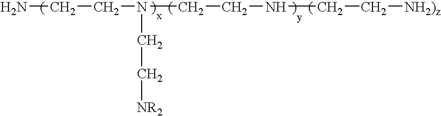

wherein x, y and z each independently represent an integer of 1 to 3,000, and R represents a hydrogen atom or a nitrogen atom-containing hydrocarbon group. More specifically, preferred examples thereof include diethylenetriamine and triethylenetetramine. R was thus defined to indicate that R may have recurring units repeated x times, y times and z times in the above formula, respectively. A plurality of Rs may be the same or different. There is no particular limitation oh the sequences of the units repeated x times, y times and z times, respectively, and the sequences may be made, for example, by random polymerization, block polymerization, or random/block mixed polymerization.

In the present invention, a commercially available product may be used for the polyamine compound.

Examples of the commercially available product that may be used include polyethyleneimine (EPOMIN SP-018 with an M_{w} (weight average molecular weight) of 1,800 manufactured by Nippon Shokubai Co., Ltd.) and polyethyleneimine (EPOMIN SP-200 with an M_{w} of 10,000 manufactured by Nippon Shokubai Co., Ltd.).

In the present invention, it is preferable for the polyamine compound to also have two or more hydroxy groups, because the resulting thermoplastic elastomer (composition) of the prevent invention can have reduced odor while achieving excellent sheet formability and extrusion moldability.

An example of the polyamine compound also having two or more hydroxy groups (hereinafter referred to as the “hydroxy group-containing polyamine compound”) includes a compound such as the above-mentioned polyethyleneimine in which the primary amino groups and/or the secondary amino groups are blocked with ethylene oxide, propylene oxide or the like. As will be illustrated in the Examples, this blocking is conducted so that at least two primary amino groups remain in the hydroxy group-containing polyamine compound.

The thermoplastic elastomer of the present invention is one obtained by reacting the aforementioned elastomeric polymer containing a cyclic acid anhydride group in its side chain and the aforementioned polyamine compound.

This reaction involves mixing the elastomeric polymer containing a cyclic acid anhydride group in its side chain and the polyamine compound to promote the reaction for ring opening of the cyclic acid anhydride group at a temperature (for example, 80 to 200° C.) allowing the chemical bonding of the cyclic acid anhydride group of the elastomeric polymer and the primary amino group of the polyamine compound.

In the present invention, the thermoplastic elastomer is preferably obtained by reacting the elastomeric polymer containing a cyclic acid anhydride group in its side chain with the polyamine compound and a polyol compound. When the elastomeric polymer containing a cyclic acid anhydride group in its side chain is reacted with not only the polyamine compound but also a polyol compound, the resulting thermoplastic elastomer exhibits more enhanced mechanical strength (and in particular elongation at break).

Next, the polyol compound that may be used to produce a preferred thermoplastic elastomer is described in detail.

### (Polyol Compound)

There is no particular limitation on the molecular weight and skeleton of the polyol compound as long as it contains two or more hydroxy groups, and examples thereof include polyether polyols (polyalkylene glycol condensation products), polyester polyols, alkylene oxide-copolymerized polyols, epoxy resin-modified polyols, other polyols, and mixtures thereof.

Exemplary polyether polyols include polyols produced by adding at least one member selected from ethylene oxide, propylene oxide, butylene oxide, styrene oxide, and the like to at least one member selected from polyhydric alcohols such as ethylene glycol, diethylene glycol, propylene glycol, dipropylene glycol, glycerine, 1,1,1-trimethylolpropane, 1,2,5-hexanetriol, 1,3-butanediol, 1,4-butanediol, 4,4′-dihydroxyphenylpropane, 4,4′-dihydroxyphenylmethane, and pentaerythritol (e.g., polyethylene glycol, polypropylene glycol, polytetramethylene glycol); polyoxytetramethylene oxide; polytetramethylene ether glycol, poly(ethylene glycol-tetramethylene glycol), poly(ethylene glycol-propylene glycol), poly(propylene glycol-tetramethylene glycol), poly(ethylene glycol-propylene glycol-tetramethylene glycol), polyethylene glycol glyceryl ether, polyethylene glycol bisphenol A ether, polyethylene glycol/polypropylene glycol/bisphenol A ether; a reaction product of isocyanuric acid and ethylene oxide (e.g., tris(2-hydroxyethyl)isocyanurate represented by the following structural formula:

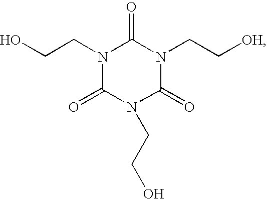

and a reaction product of isocyanuric acid and propylene oxide. These may be used alone or in combination of two or more.

Exemplary polyester polyols include condensation polymers of one or more low molecular weight polyols such as ethylene glycol, propylene glycol, butanediol pentanediol, hexanediol, cyclohexane dimethanol, glycerine, and 1,1,1-trimethylolpropane with one or more of low molecular weight carboxylic acids and oligomeric acids such as glutaric acid, adipic acid, pimelic acid, suberic acid, sebacic acid, terephthalic acid, isophthalic acid, and dimer acid; and polymers produced by ring opening such as propiolactone and valerolactone. These may be used alone or in combination of two or more.

Exemplary alkylene oxide-copolymerized polyols include a tetrahydrofuran-propylene oxide copolymer (THF-PO copolymer) and a tetrahydrofuran-ethylene oxide copolymer (THF-EO copolymer). These may be used alone or in combination of two or more.

An exemplary epoxy resin-modified polyol includes bisphenol A epoxy resin-modified ethylene glycol.

Exemplary other polyols include polymer polyol, polycarbonate polyol; polybutadiene polyol; hydrogenated polybutadiene polyol; acrylic polyol; low molecular weight polyols such as ethylene glycol, diethylene glycol, propylene glycol, tetramethylene glycol, dipropylene glycol, butanediol, pentanediol and hexanediol; polyalkylene glycol alkylamines such as polyethylene glycol laurylamine (for example, N,N-bis(2-hydroxyethyl)laurylamine), polypropylene glycol laurylamine (for example, N,N-bis(2-methyl-2-hydroxyethyl)laurylamine) and polyethylene glycol octylamine (for example, N,N-bis(2-hydroxyethyl)octylamine), polypropylene glycol octylamine (for example, N,N-bis(2-methyl-2-hydroxyethyl)octylamine), polyethylene glycol stearylamine (for example, N,N-bis(2-hydroxyethyl)stearylamine), polypropylene glycol stearylamine (for example, N,N-bis(2-methyl-2-hydroxyethyl)stearylamine); and fatty acid diethanolamides. These may be used alone or in combination of two or more.

Of those, polyether polyols are preferably used to further enhance the resistance to compression set, and polyethylene glycol glyceryl ether is more preferred.

In the present invention, a commercially available product may be used for the polyether polyol.

An example of the commercially available product that may be used includes polyethylene glycol glyceryl ether (UNIOX G450 manufactured by NOF Corporation) represented by the following structural formula:

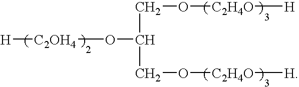

On the other hand, the thermoplastic elastomer of the present invention has the structure represented by the following formula (1):

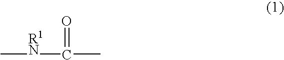

wherein R¹ is a hydrogen atom or a hydrocarbon group which may contain at least one heteroatom selected from the group consisting of O, N and S.

The “hydrocarbon group which may contain at least one heteroatom selected from the group consisting of O, N and S” in the definition of R¹ of the formula (1) is used to include as the substituent another elastomeric polymer whose cyclic acid anhydride group was reacted with imino group (in this case R¹ is a hydrogen atom) generated by the reaction between the elastomeric polymer containing a cyclic acid anhydride group in its side chain and the polyamine compound.

The elastomeric polymer containing a cyclic acid anhydride group in its side chain is reacted with the polyamine compound to cause ring opening of the cyclic acid anhydride group to thereby obtain the structure represented by the formula (1).

Therefore, the thermoplastic elastomer of the present invention preferably has the structure represented by the formula (1) as a structure which is represented by the following formula (2):

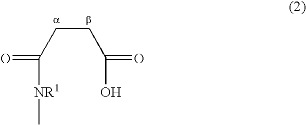

(wherein R¹ is a hydrogen atom or a hydrocarbon group which may contain at least one heteroatom selected from the group consisting of O, N and S), the structure being attached to its main chain at α or β position.

The substituent R¹ of the formula (2) is basically the same as the substituent R¹ of the formula (1).

The thermoplastic elastomer of the present invention preferably has at least one of the structures represented by the formulae (5) to (7):

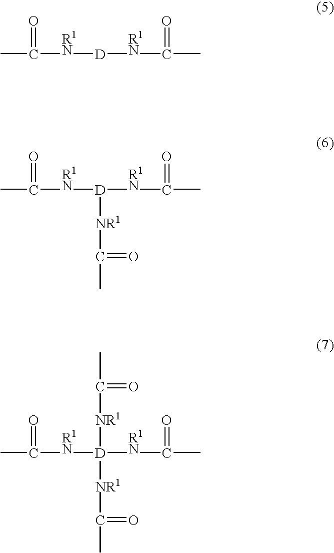

wherein R¹ is a hydrogen atom or a hydrocarbon group which may contain at least one heteroatom selected from the group consisting of O, N and S, and D is a hydrocarbon group having 1 to 20 carbon atoms which may contain oxygen atom, sulfur atom or nitrogen atom and which may be branched.

The substituent R¹ is basically the same as the substituent R¹ of the formula (1).

Specific examples of the substituent D include alkylene groups such as methylene group, ethylene group, 1,3-propylene group, 1,4-butylene group, 1,5-pentylene group, 1,6-hexylene group, 1,7-heptylene group, 1,8-octylene group, 1,9-nonylene group, 1,10-decylene group, 1,11-undecylene group, and 1,12-dodecylene group; N,N-diethyldodecylamine-2,2′-diyl, N,N-dipropyldodecylamine-2,2′-diyl, N,N-diethyloctylamine-2,2′-diyl, N,N-dipropyloctylamine-2,2′-diyl, N,N-diethylstearylamine-2,2′-diyl, N,N-dipropylstearylamine-2,2′-diyl; vinylene group; divalent alicyclic hydrocarbon groups such as 1,4-cyclohexylene group; divalent aromatic hydrocarbon groups such as 1,4-phenylene group, 1,2-phenylene group, 1,3-phenylene group, and 1,3-phenylene bis(methylene)group; trivalent hydrocarbon groups such as propane-1,2,3-triyl, butane-1,3,4-triyl, trimethylamine-1,1′,1″-triyl, and triethylamine-2,2′,2″-triyl; tetravalent hydrocarbon groups represented by the following formulae (8) and (9):

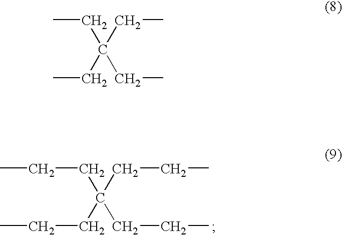

and substituents formed by combinations thereof. Among these, the substituent D preferably has secondary amino group, more preferably has branched carbon and/or branched nitrogen, and even mere preferably has tertiary amino group.

In addition, it is more preferable for the thermoplastic elastomer of the present invention to have the structure represented by any of the formulae (5) to (7) as a structure which is represented by any of the following formulae (10) to (12):

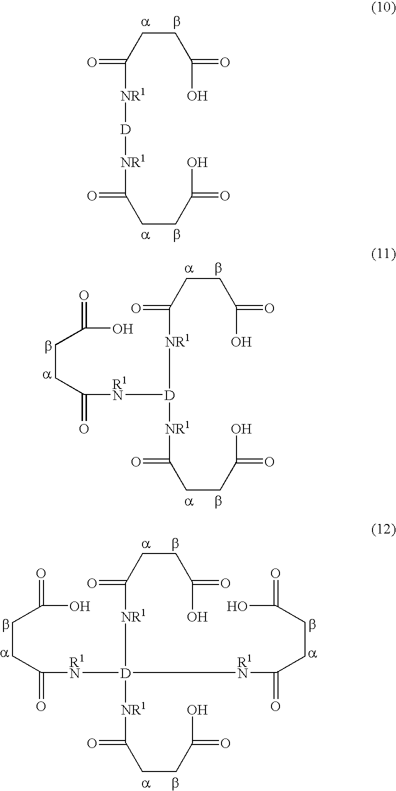

(wherein R¹ is a hydrogen atom or a hydrocarbon group which may contain at least one heteroatom selected from the group consisting of O, N and S, and D is a hydrocarbon group having 1 to 20 carbon atoms which may contain oxygen atom, sulfur atom or nitrogen atom and which may be branched), the structure being attached to its main chain at α or β position.

The substituent R¹ is basically the same as the substituent R¹ of the formula (1), and the substituent D is basically the same as the substituent D in the formulae (5) to (7).

When the substituent R¹ in the formulae (10) to (12) is a hydrogen atom, the structures represented by the formulae (10) to (12) may be ones imidized through dehydration and represented by the following formulae (10′) to (12′):

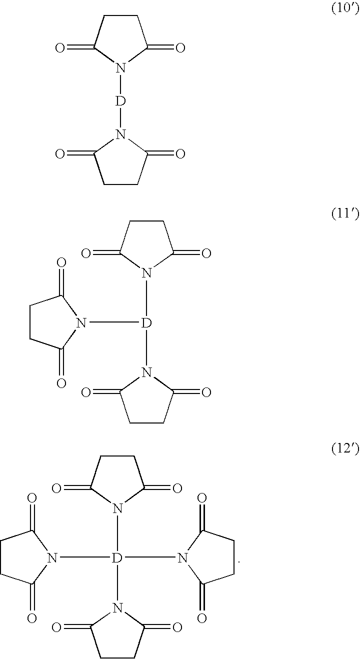

The structure represented by any of the formulae (10) to (12) is preferably a structure represented by any of the following formulae (13) to (15):

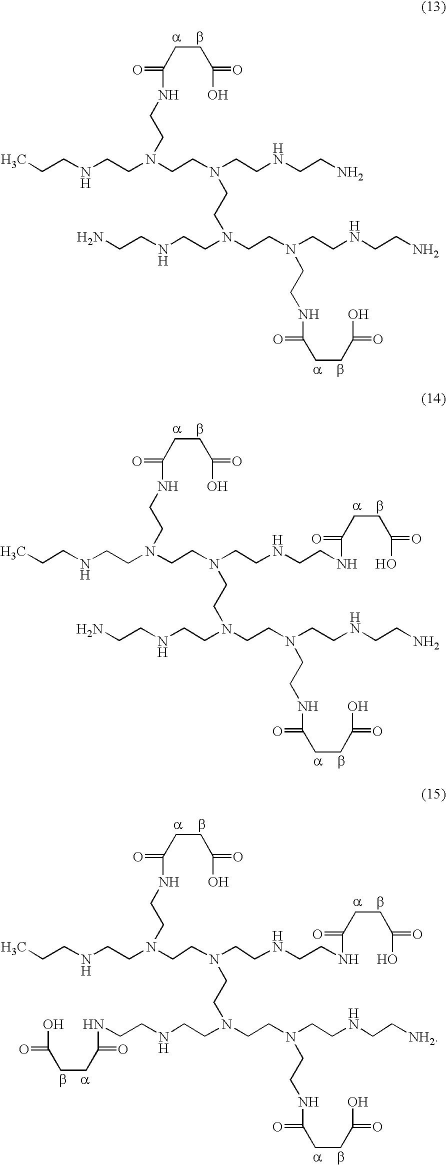

### These structures may be ones imidized through dehydration and represented by the following formulae (13′) to (15′):

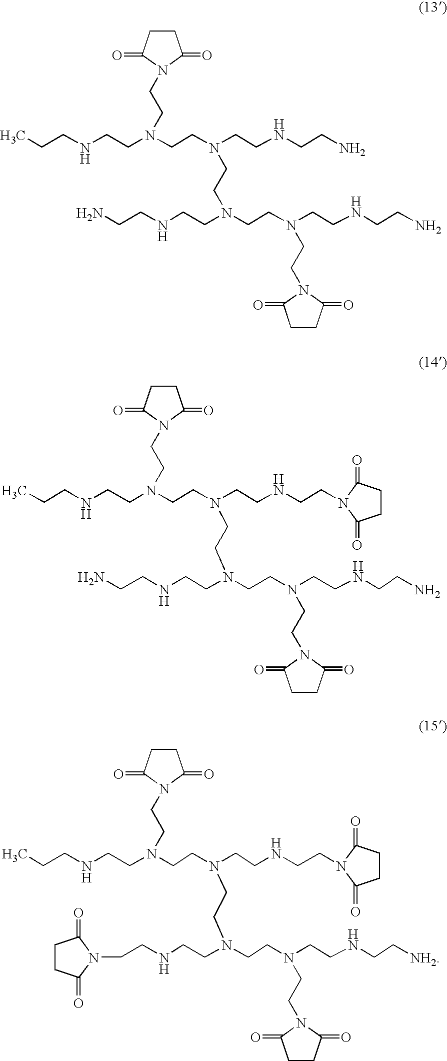

The thermoplastic elastomer of the present invention preferably has a structure represented by the following formula (3):

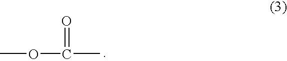

In the reaction of the elastomeric polymer containing a cyclic acid anhydride group in its side chain with the polyamine compound and the polyether polyol, the elastomeric polymer containing the cyclic acid anhydride group in its side chain is reacted with the polyether polyol to cause ring opening of the cyclic acid anhydride group to thereby produce the structure represented by the formula (3).

Therefore, the thermoplastic elastomer of the present invention preferably has the structure represented by the formula (3) as a structure which is represented by the following formula (4):

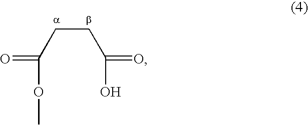

the structure being attached to its main chain at α or β position.

The thermoplastic elastomer of the present invention preferably has at least one of the structures represented by the formulae (16) to (18):

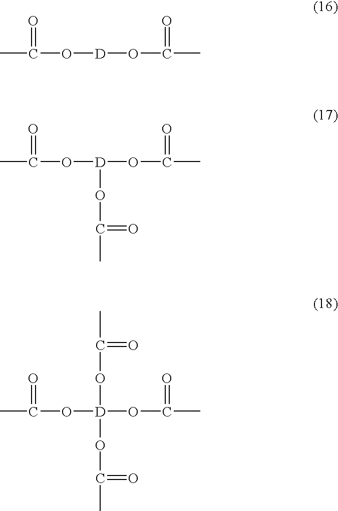

wherein D is a hydrocarbon group having 1 to 20 carbon atoms which may contain oxygen atom, sulfur atom or nitrogen atom and which may be branched.

The substituent D is basically the same as the substituent D in the formulae (5) to (7). However, the substituent D preferably has branched carbon, and more preferably tertiary hydrocarbon group (≡CH).

In addition, it is more preferable for the thermoplastic elastomer of the present invention to have the structure represented by any of the formulae (16) to (18) as a structure which is represented by any of the following formulae (19) to (21):

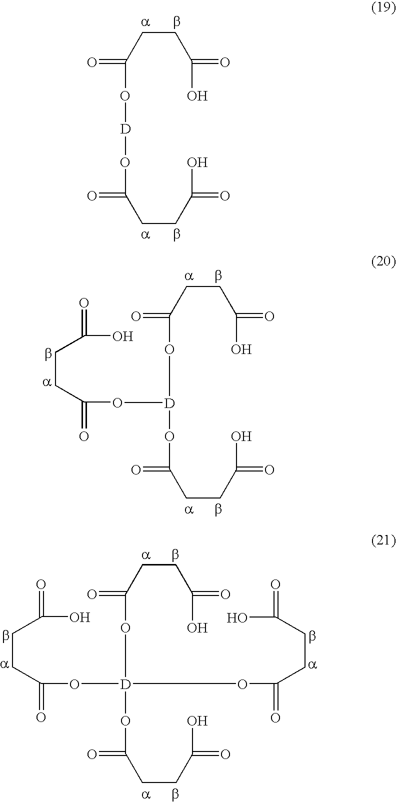

(wherein D is a hydrocarbon group having 1 to 20 carbon atoms which may contain oxygen atom, sulfur atom or nitrogen atom and which may be branched), the structure being attached to its main chain at α or β position.

The substituent D is basically the same as the substituent D in the formulae (16) to (18).

The structure represented by any of the formulae (19) to (21) is preferably a structure represented by any of the following formulae (22) and (23):

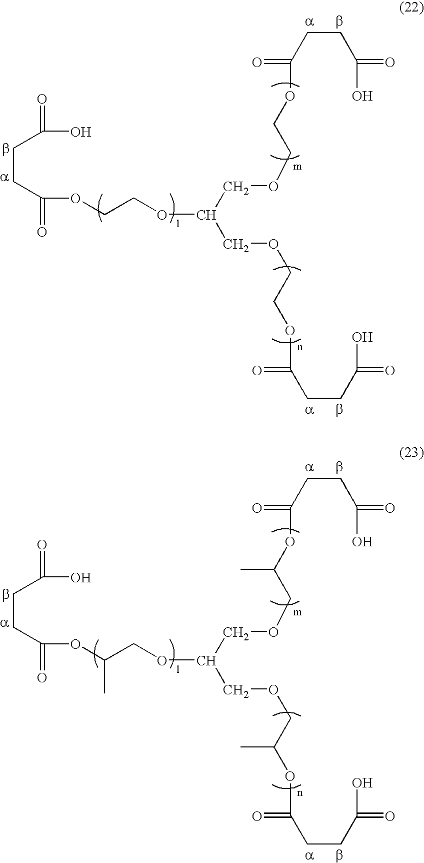

wherein l, m and n each independently are an integer of at least 1.

In the case where the above-mentioned hydroxy group-containing polyamine compound is used for the polyamine compound, the thermoplastic elastomer of the present invention preferably has a structure represented by the following formula (24):

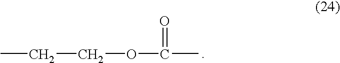

The structure represented by the formula (24) is produced by the reaction between the elastomeric polymer containing a cyclic acid anhydride group in its side chain and the hydroxy group-containing polyamine compound.

Therefore, the thermoplastic elastomer of the present invention preferably has the structure represented by the formula (24) as a structure which is represented by the following formula (25):

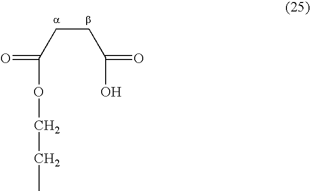

the structure being attached to its main chain at α or β position.

The thermoplastic elastomer of the present invention preferably has a glass transition point of up to 25° C. When the thermoplastic elastomer has two or more glass transition points or when two or more thermoplastic elastomers are used in combination, at least one of the glass transition points is preferably up to 25° C. A molded article will exhibit rubber elasticity at room temperature when the glass transition point of the elastomeric polymer is up to 25° C.

Next, the composition of the present invention containing the thermoplastic elastomer of the present invention is described.

The composition of the present invention contains at least one thermoplastic elastomer according to the first aspect of the present invention. When two or more thermoplastic elastomers are used in combination, their mixing ratio may be adequately selected depending on the application of the composition, and the physical properties and other factors required for the composition.

The composition of the present invention preferably contains at least one reinforcing agent selected from carbon black and silica.

The type of the carbon black used may be selected as appropriate for the application of the composition. Carbon black is generally classified into hard carbon and soft carbon based on the particle size. Soft carbon has a relatively low reinforcing effect on rubbers whereas hard carbon has a high reinforcing effect on rubbers. In the present invention, it is particularly preferable to use hard carbon having a high reinforcing effect.

The content of such carbon black (when used alone) is 0.1 to 200 parts by weight, preferably 1 to 100 parts by weight, and more preferably 1 to 80 parts by weight with respect to 100 parts by weight of the thermoplastic elastomer of the present invention.

Silica is used without any particular limitation and specific examples thereof include fumed silica, calcined silica, precipitated silica, pulverized silica, molten silica, and diatomaceous earth. Such silica is incorporated (when used alone) in a content of 0.1 to 200 parts by weight, preferably 1 to 100 parts by weight, and more preferably 1 to 80 parts by weight with respect to 100 parts by weight of the thermoplastic elastomer of the present invention. Of these, precipitated silica is preferably used.

When silica is used for the reinforcing agent, it may be used in combination with a silane coupling agent. Examples of the silane coupling agent include bis(triethoxysilylpropyl)tetrasulfide (Si69), bis(triethoxysilylpropyl)disulfide (Si75), γ-mercaptopropyltrimethoxysilane, and vinyltrimethoxysilane, and an aminosilane compound to be described below may also be employed.

When used in combination, carbon black and silica may be incorporated in a total content of 0.1 to 200 parts by weight, preferably 1 to 100 parts by weight, and more preferably 1 to 80 parts by weight with respect to 100 parts by weight of the thermoplastic elastomer of the present invention.

If necessary, the composition of the present invention may optionally contain a polymer other than the thermoplastic elastomer of the present invention, a reinforcing agent (filler) other than carbon black and silica, a filler having amino group introduced therein (hereinafter simply referred to as an “amino group-introduced filler”), an amino group-containing compound other than the amino group-introduced filler, a compound containing a metal element (hereinafter simply referred to as a “metal salt”), a maleic anhydride-modified polymer, an antiaging agent, an antioxidant, a pigment (dye), plasticizer, a thixotropic agent, a UV absorbent, a flame retardant, a solvent, a surfactant (including a leveling agent), a dispersant, a dehydrating agent, an anticorrosive, an adhesion promoter, an antistatic agent, a filler, and various ether additives as long as the object of the present invention is not impaired.

Such polymers and additives may be commonly used ones, and some examples are described below in a non-limiting manner.

The polymer other than the thermoplastic elastomer of the present invention is preferably a polymer having a glass transition temperature of up to 25° C. for the same reason as described above. Specific examples thereof include natural rubber (NR), isoprene rubber (IR), butadiene rubber (BR), 1,2-butadiene rubber, styrene-butadiene rubber (SBR), acrylonitrile-butadiene rubber (NBR), butyl rubber (IIR), ethylene-propylene-diene rubber (EPDM), ethylene-propylene rubber (EPM), ethylene-acrylic rubber (AEM), and ethylene-butene rubber (EBM), and polymers having no unsaturated bond such as IIR, EPM, and EBM or the polymers having few unsaturated bonds such as EPDM are particularly preferred. Also preferred are polymers having the moiety capable of undergoing hydrogen bonding, and exemplary such polymers include polyester, polylactone, and polyamide. Thermoplastic polymers such as flexible polyolefin resins, propylene-butene copolymers and ethylene-octene or ethylene-butene copolymers may also be used.

The composition of the present invention may contain either one polymer or two or more polymers in addition to the thermoplastic elastomer of the present invention, and such polymer is preferably incorporated in a content of 0.1 to 200 parts by weight, and more preferably 1 to 100 parts by weight with respect to 100 parts by weight of the thermoplastic elastomer of the present invention.

Exemplary reinforcing agents other than carbon black and silica include iron oxide, zinc oxide, aluminum oxide, titanium oxide, barium oxide, magnesium oxide, calcium carbonate, magnesium carbonate, zinc carbonate, pyrophyllite clay, kaolin clay, and calcined clay. Such reinforcing agents are preferably incorporated in a content of 0.1 to 200 parts by weight and more preferably 1 to 100 parts by weight with respect to 100 parts by weight of the thermoplastic elastomer of the present invention.

Those illustrated for the filler that may be added as desired to the crosslinked rubber may be used as the filler serving as the base of the amino group-introduced filler (hereinafter also referred to simply as the “base filler”). In consideration of ease of introduction of amino groups and ease of adjusting the rate of amino groups introduced (introduction rate), silica, carbon black, and calcium carbonate are preferred, with silica being more preferred.

The amino group introduced in the base filler (hereinafter sometimes simply referred to as the “amino group”) is not particularly limited, and exemplary amino groups include aliphatic amino groups, aromatic amino groups, heterocyclic amino groups, and mixtures of such amino groups.

In the present invention, the amino group included in an aliphatic amine compound is referred to as the “aliphatic amino group”, the amino group attached to the aromatic group of an aromatic amine compound is referred to as the “aromatic amino group”, and the amino group included in a heterocyclic amine compound is referred to as the “heterocyclic amino group”.

Among these, it is preferable to use a heterocyclic amino group, a mixed amino group containing a heterocyclic amino group, or an aliphatic amino group, and more preferably a heterocyclic amino group or an aliphatic amino group, because these groups appropriately form an interaction with the thermoplastic elastomer of the present invention and can be effectively dispersed in the thermoplastic elastomer.

The amino group is not particularly limited as to whether it is primary (—NH₂), secondary (imino group, >NH), tertiary (>N—), or quarternary (>N⁺<).

When the amino group is a primary amino group, the interaction with the thermoplastic elastomer of the present invention tends to be enhanced, and gelation may take place depending on the conditions used in preparing the composition. On the other hand, when the amino group is a tertiary amino group, the interaction with the thermoplastic elastomer of the present invention tends to be weakened, and the effect of improving the resistance to compression set and the like the resulting composition should have may often be insufficient.

In view of such situation, the amino group is preferably a primary or secondary amino group, and more preferably a secondary amino group.

In other words, the amino group is preferably a heterocyclic amino group, a mixed amino group containing a heterocyclic amino group, or a primary or secondary aliphatic amino group, and more preferably a heterocyclic amino group or a primary or secondary aliphatic amino group.

The base filler may have at least one amino group on its surface. However, the base filler may preferably have two or more amino groups on its surface because the resulting composition is excellent in the effect of improving the resistance to compression set and other properties.

When the base filler has two or more amino groups, at least one of the two or more amino groups is preferably a heterocyclic amino group, and more preferably the base filler also has a primary or secondary amino group (aliphatic amino group, aromatic amino group, or heterocyclic amino group).

The type and the classification (primary, secondary, tertiary or quaternary) of the amino group may be adequately selected depending on the physical properties required for the composition.

The amino group-introduced filler is produced by introducing the amino group in the base filler.

The method used for introducing the amino group is not particularly limited, and specific examples thereof include surface treatment methods (for example, surface modifying method and surface covering method) commonly used in producing various fillers and reinforcing agents. Exemplary preferable methods include the surface modifying method in which a compound having a functional group capable of reacting with the base filler and the amino group is reacted with the base filler; the surface covering method in which the surface of the base filler is coated with an amino group-containing polymer; and a method in which an amino group-containing compound is reacted with the filler in the step of the filler synthesis.

Such amino group-introduced fillers may be used either alone or in combination of two or more. When two or more amino group-introduced fillers are used in combination, their mixing ratio may be adequately selected depending on the application of the composition of the present invention, and the physical properties and other factors required for the composition of the present invention.

Such amino group-introduced filler is preferably used in a content of 0.1 to 200 parts by weight, more preferably 10 parts by weight or more, and most preferably 30 parts by weight or more with respect to 100 parts by weight of the thermoplastic elastomer of the present invention.

Next, the amino group-containing compound other than the amino group-introduced filler is described.

The amino group in the amino group-containing compound may be basically the same as the one described for the amino group-introduced filler, and the number of amino groups is not particularly limited as long as the amino group-containing compound has at least one amino group. The amino group-containing compound, however, may preferably have two or more amino groups since the compound will then be capable of forming two or more crosslinks with the thermoplastic elastomer of the present invention to improve more effectively the physical properties.

The classification (primary, secondary, tertiary or quaternary) of the amino group in the amino group-containing compound is not particularly limited, and as in the case of the amino group-introduced filler, the amino group may be primary (—NH₂), secondary (imino group, >NH), tertiary (>N—), or quarternary (>N⁺<) depending on the recyclability, resistance to compression set, hardness, mechanical strength (in particular tensile strength), and other physical properties required for the composition of the present invention. When a secondary amino group is selected, the amino group-containing compound is likely to have a superior mechanical strength, whereas the amino group-containing compound is likely to have a superior recyclability when a tertiary amino group is selected. Use of an amino group-containing compound having two secondary amino groups is particularly preferred since the resulting composition of the present invention will exhibit excellent and well-balanced recyclability, resistance to compression set and mechanical strength.

When the amino group-containing compound has two or more amino groups, the number of primary amino groups in the compound is preferably up to two, and more preferably up to one. When the compound has three or more primary amino groups, the crosslink formed by these amino groups and the functional group (in particular carboxy group that is a carbonyl-containing group) of the thermoplastic elastomer of the present invention may become excessively firm to detract from the excellent recyclability.

In other words, the classification of the amino group, the number of amino groups, and the structure of the amino group-containing compound may be adequately adjusted and selected depending on the binding force between the functional group in the thermoplastic elastomer of the present invention and the amino group in the amino group-containing compound.

Exemplary amino group-containing compounds include secondary aliphatic diamines such as diethylenetriamine, triethylenetetramine, N,N′-dimethylethylenediamine, N,N′-diethylethylenediamine, N,N′-diisopropylethylenediamine, N,N′-dimethyl-1,3-propanediamine, N,N′-diethyl-1,3-propanediamine, N,N′-diisopropyl-1,3-propanediamine, N,N′-dimethyl-1,6-hexanediamine, N,N′-diethyl-1,6-hexanediamine, and N,N′,N″-trimethylbis(hexamethylene)triamine; tertiary aliphatic diamines such as tetramethyl-1,6-hexanediamine; polyamines containing an aromatic primary amine and a heterocyclic amine such as aminotriazole, and aminopyridine; straight chain alkylmonoamines such as dodecylamine; and tertiary heterocyclic diamines such as dipyridyl. These compounds are highly effective in improving resistance to compression set and mechanical strength (in particular tensile strength) and are therefore preferable.

Among these, secondary aliphatic diamines, polyamines containing an aromatic primary amine and a heterocyclic amine, and tertiary heterocyclic diamines are more preferred.

In addition to those mentioned above, the amino group-containing compound may also be an amino group-containing polymer compound.

The amine group-containing polymer compound is not particularly limited, and examples thereof include polymers such as polyamide, polyurethane, urea resin, melamine resin, polyvinylamine, polyallylamine, polyaerylamide, polymethacrylamide, polyaminostyrene, and amino group-containing polysiloxane, and polymers prepared by modifying various polymers with an amino group-containing compound.

There is no particular limitation on the average molecular weight, molecular weight distribution, viscosity, and other physical properties of these polymers, and the physical properties may be adequately selected depending on the application of the composition of the present invention, and the physical properties and other factors required for the composition of the present invention.

The amino group-containing polymer compound is preferably a polymer produced by polymerizing (through polyaddition or polycondensation) an amino group-containing, condensable or polymerizable compound (monomer). More preferably, the amino group-containing polymer compound is an amino group-containing polysiloxane which is a homo-condensation product of a silyl compound having a hydrolyzable substituent and the amino group, or a co-condensation product of such silyl compound with a silyl compound having no amino group, in view of availability, ease of production, ease of adjusting the molecular weight, ease or adjusting the rate of amino groups introduced, and the like.

The silyl compound having a hydrolyzable substituent and the amino group is not particularly limited, and exemplary compounds are aminosilane compounds which include aminosilane compounds having an aliphatic primary amino group such as γ-aminopropyltrimethexysilane, γ-aminopropyltriethoxysilane, γ-aminopropylmethyldimethoxysilane, γ-aminopropylmethyldiethoxysilane, and 4-amino-3,3-dimethylbutyltrimethoxysilane (these compounds, being manufactured by Nippon Unicar Co., Ltd.); aminosilane compounds having an aliphatic secondary amino group such as N,N-bis[(3-trimethoxysilyl)propyl]amine, N,N-bis[(3-triethoxysilyl)propyl]amine, N,N-bis[(3-tripropoxysilyl)propyl]amine (these compounds being manufactured by Nippon Unicar Co., Ltd.), 3-(n-butylamino)propyltrimethoxysilane (Dynasilane 1189 manufactured by Degussa-Hüls), and N-ethyl-aminoisobutyltrimethoxysilane (Silquest A-Link 15 silane manufactured by OSi Specialties); aminosilane compounds having an aliphatic primary and an aliphatic secondary amino group such as N-β(aminoethyl)γ-aminopropylmethyldimethoxysilane, N-β(aminoethyl)γ-aminopropyltrimethoxysilane, and N-β(aminoethyl)γ-aminopropyltriethoxysilane (manufactured by Nippon Unicar Co., Ltd.); aminosilane compounds having an aromatic secondary amino group such as N-phenyl-γ-aminopropyltrimethoxysilane (manufactured by Nippon Unicar Co., Ltd.); and aminosilane compounds having a heterocyclic amino group such as imidazole trimethoxysilane (manufactured by Japan Energy Corporation) and triazole silane produced by reacting aminotriazole with an epoxysilane compound, an isocyanate silane compound, or the like in the presence or absence of a catalyst at room temperature or a higher temperature.

Among these, aminoalkylsilane compounds such as aminosilane compounds having an aliphatic primary amino group, aminosilane compounds having an aliphatic secondary amino group, and aminosilane compounds having an aliphatic primary and an aliphatic secondary amino group are preferable in view of their high effectivity in improving the resistance to compression set and other physical properties.

The silyl compound having no amino group is not particularly limited as long as it is a compound which is different from the silyl compound having a hydrolyzable substituent and the amino group and which contains no amino group. Examples thereof include alkoxysilane compounds and halogenated silane compounds. Among these, alkoxysilane compounds are preferable in view of their availability, ease of handling, and excellent physical properties of the resulting co-condensation product.

Exemplary alkoxysilane compounds include tetramethoxysilane, tetraethoxysilane, tetrabutoxysilane, tetraisopropoxysilane, methyltrimethoxysilane, methyltriethoxysilane, methyltributoxysilane, methyltriisopropoxysilane, phenyltrimethoxysilane, and dimethyldimethoxysilane.

Exemplary halogenated silane compounds include tetrachlorosilane and vinyl trifluorosilane.

Among these, tetraethoxysilane and tetramethoxysilane are preferable in view of their low price and safety in handling.

The silyl compounds having a hydrolyzable substituent and the amino group and the silyl compounds having no amino group may be used either alone or in combination of two or more.

Such amino group-containing polymer compounds may be used either alone or in combination of two or more. When two or more such amino group-containing polymer compounds are used in combination, their mixing ratio may be adequately selected depending on the application of the composition of the present invention, and the physical properties and other factors required for the composition of the present invention.

The content of the amino group-containing polymer compound can be defined by the number (equivalent) of nitrogen atoms in the compound with respect to the side chain of the thermoplastic elastomer of the present invention as in the amino group-containing compound as described above. However, there may exist same amino groups incapable of effectively undergoing interaction with the thermoplastic elastomer depending on the structure, molecular weight, and the other of the polymer compound.

Accordingly, the content of the amino group-containing polymer compound is preferably 1 to 200 parts by weight, more preferably 5 parts by weight or more, and most preferably 10 parts by weight or more with respect to 100 parts by weight of the thermoplastic elastomer of the present invention.

The metal salt is not particularly limited as long as it is a compound containing at least one metal element, and the metal salt is preferably a compound containing at least one metal element selected from the group consisting of Li, Na, K, Ti, V, Cr, Mn, Fe, Co, Ni, Cu, Zn, Ga, and Al.

Examples of the metal salt include a salt of a C₁-C₂₀ saturated fatty acid such as formate, acetate, and stearate of at least one of the above-mentioned metal elements; a salt of an unsaturated fatty acid such as (meth)acrylate; a metal alkoxide (a reaction product with an alcohol containing 1 to 12 carbon atoms); a nitrate, a carbonate, a hydrogencarbonate, a chloride, an oxide, a hydroxide of such metal, and a metal complex with a diketone.

The “complex with a diketone” as used herein designates a complex formed by coordination of a metal atom with, for example, a 1,3-diketone (for example, acetyl acetone).

Among these, the metal element is preferably Ti, Al, or Zn, and the metal salt is preferably a salt of a saturated fatty acid containing 1 to 20 carbon atoms such as acetate or stearate, a metal alkoxide (a reaction product with an alcohol containing 1 to 12 carbon atoms), a metal oxide, a metal hydroxide, and a metal complex with a diketone, and more preferably a salt of a saturated fatty acid containing 1 to 20 carbon atoms such as stearate, a metal, alkoxide (a reaction product with an alcohol containing 1 to 12 carbon atoms), and a metal complex with a diketone.

The metal salts may be used either alone or in combination of two or more. When two or more metal salts are used in combination, their mixing ratio may be adequately selected depending on the application of the composition of the present invention, and the physical properties and other factors required for the composition of the present invention.

The content of such metal salt is preferably 0.05 to 3.0 equivalents, more preferably 0.1 to 2.0 equivalents, and most preferably 0.2 to 1.0 equivalents with respect to the carbonyl group in the thermoplastic elastomer of the present invention. When the content of the metal salt is within such range, the resulting composition of the present invention will exhibit improved physical properties such as resistance to compression set, hardness and mechanical strength (in particular tensile strength).

The metal salt used may be any one of the possible hydroxides, alkoxides, and carboxylates of metals. For example, in the ease of hydroxide, the metal salt in the case where the metal is iron may be either Fe(OH)₂ or Fe(OH)₃, and these metal salts may also be used as a mixture.

As described above, the metal salt is preferably a compound containing at least one metal element selected from the group consisting of Li, Na, K, Ti, V, Cr, Mn, Fe, Co, Ni, Cu, Zn, Ga, and Al. However, the metal salt may also contain a metal element other than the above-mentioned metal elements in an amount that does not adversely affect the merits of the present invention. Although the content of the metal element other than the above-mentioned metal elements is not particularly limited, such metal element is preferably incorporated in an amount of 1 to 50 mol % with respect to all metal elements in the metal salt.

The maleic anhydride-modified polymer is a polymer produced by modifying the elastomeric polymer as described above with maleic anhydride. Although the side chain of the maleic anhydride-modified polymer may contain a functional group other than the maleic anhydride residue and the nitrogen-containing heterocycle, the side chain preferably contains only the maleic anhydride residue.

The maleic anhydride residue is not introduced in the main chain of the elastomeric polymer but is introduced (for modification) in the side chain or at the terminal of the elastomeric polymer. In addition, the maleic anhydride residue is a cyclic acid anhydride group, and this cyclic acid anhydride group (moiety) will not undergo ring opening.

Accordingly, an example of the maleic anhydride-modified thermoplastic polymer is a thermoplastic elastomer having no nitrogen-containing heterocycle but a cyclic acid anhydride group in the side chain as shown in the formula (26):

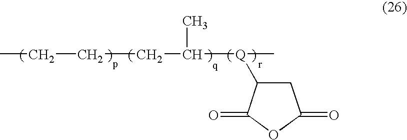

wherein Q represents an ethylene residue or propylene residue, and p, q, and r each independently represent a number of 0.1 to 99. This thermoplastic elastomer is produced by the reaction of ethylenically unsaturated bond of the maleic anhydride with the elastomeric polymer, and specific examples are those mentioned above for the elastomeric polymer having a cyclic acid anhydride group in its side chain.

The degree of modification with maleic anhydride is preferably 0.1 to 50 mol %, more preferably 0.3 to 30 mol %, and most preferably 0.5 to 10 mol % with respect to 100 mol % of the main chain moiety of the elastomeric polymer in view of the ability of improving the resistance to compression set without adversely affecting the excellent recyclability.

The maleic anhydride-modified polymers may be used either alone or in combination of two or more. When two or more maleic anhydride-modified polymers are used in combination, their mixing ratio may be adequately selected depending on the application of the composition of the present invention, and the physical properties and other factors required for the composition of the present invention.

The content of such maleic anhydride-modified polymer is preferably 1 to 100 parts by weight, and more preferably 5 to 50 parts by weight with respect to 100 parts by weight of the thermoplastic elastomer of the present invention. When the content of the maleic anhydride-modified polymer is within such range, the resulting composition of the present invention will exhibit improved workability and mechanical strength.

When the elastomeric polymer having a cyclic acid anhydride group in its side chain remains unreacted in the production of the thermoplastic elastomer of the present invention, the remaining elastomer modified with the carbonyl-containing group may not be removed but be included as such in the composition of the present invention.

Examples of the antiaging agent include hindered phenol compounds and aliphatic and aromatic hindered amine compounds.

Examples of the antioxidant include butylhydroxytoluene (BHT), and butylhydroxyanisole (BHA).

Examples of the pigment include inorganic pigments such as titanium dioxide, zinc oxide, ultramarine, iron red, lithopone, lead, cadmium, iron, cobalt, aluminum, hydrochloride, and sulfate; organic pigments such as azo pigment and copper phthalocyanine pigment.

Examples of the plasticizer include derivatives of benzoic acid, phthalic acid, trimellitic acid, pyromellitic acid, adipic acid, sebacic acid, fumaric acid, maleic acid, itaconic acid, and citric acid; polyester plasticizers; polyether plasticizers; and epoxy plasticizers.

Examples of the thixotropic agent include bentonite, silicic anhydride, silicic acid derivatives, and urea derivatives.

Examples of the UV absorbent include 2-hydroxybenzophenone UV absorbents, benzotriazole UV absorbents, and salicylic acid ester UV absorbents.

Examples of the flame retardant include phosphorus flame retardants such as TCP; halogen flame retardants such as chlorinated paraffin and perchloropentacyclodecane; antimony flame retardants such as antimony oxide; and aluminum hydroxide.

Examples of the solvent include hydrocarbons such as hexane and toluene; halogenated hydrocarbons such as tetrachloromethane; ketones such as acetone and methyl ethyl ketone; ethers such as diethylether and tetrahydrofuran; and esters such as ethyl acetate.

Examples of the surfactant (leveling agent) include polybutyl acrylate, polydimethylsiloxane, modified silicone compounds, and fluorosurfactants.

An example of the dehydrating agent includes vinylsilane.

Examples of the anticorrosive include various anticorrosive pigments such as zinc phosphate, tannic acid derivatives, phosphoric acid esters, and basic sulfonates.

Examples of the adhesion promoter include known silane coupling agents, silane compounds containing an alkoxysilyl group, titanium coupling agents, and zirconium coupling agents, and more specifically, trimethoxyvinylsilane, vinyltriethoxysilane, vinyl tris(2-methoxyethoxy)silane, γ-methacryloxypropyltrimethoxysilane, and 3-glycidoxypropyltrimethoxysilane.

Examples of the antistatic agent generally include quaternary ammonium salts, and hydrophilic compounds such as polyglycols and ethylene oxide derivatives.

The content of such plasticizer is preferably in the range of 0.1 to 50 parts by weight and more preferably 1 to 30 parts by weight with respect to 100 parts by weight of the thermoplastic elastomer of the present invention. The other additives are preferably incorporated in a content of 0.1 to 10 parts by weight and more preferably 1 to 5 parts by weight with respect to 100 parts by weight of the thermoplastic elastomer of the present invention.

Some of the thermoplastic elastomers of the present invention are selfcrosslinkable. The thermoplastic elastomers of the present invention, however, may optionally contain a vulcanizing agent, an accelerator activator, a vulcanization accelerator, a vulcanization retarder, and the like as long as the merit of the present invention is not impaired.

Examples of the vulcanizing agent include sulfur vulcanizing agents, organic peroxide vulcanizing agents, metal oxide vulcanizing agents, phenol resin vulcanizing agents, and quinone dioxime vulcanizing agents.

Exemplary sulfur vulcanizing agents include powdered sulfur, precipitated sulfur, highly dispersible sulfur, surface treated sulfur, insoluble sulfur, dimorpholine disulfide, and alkyl phenol disulfides.

Exemplary organic peroxide vulcanizing agents include benzoyl peroxide, t-butyl hydroperoxide, 2,4-dichlorobenzoyl peroxide, 2,5-dimethyl-2,5-di(t-butylperoxy)hexane, and 2,5-dimethylhexane-2,5-di(peroxyl benzoate).

Other vulcanizing agents include magnesium oxide, litharge (lead oxide), p-quinone dioxime, tetrachloro-p-benzoquinone, p-dibenzoylquinone dioxime, poly-p-dinitrosobenzene, and methylenedianiline.

Examples of the vulcanization aid include zinc oxide, magnesium oxide, amines; fatty acids such as acetyl acid, propionic acid, butanoic acid, stearic acid, acrylic acid, and maleic acid; zinc salts of fatty acids such as zinc acetylate, zinc propionate, zinc butanoate, zinc stearate, zinc acrylate, and zinc maleate.

Examples of the vulcanization accelerator include thiuram vulcanization accelerators such as tetramethylthiuram disulfide (TMTD) and tetraethylthiuram disulfide (TETD); aldehyde ammonia vulcanization accelerators such as hexamethylenetetramine; guanidine vulcanization accelerators such as diphenylguanidine; thiazole vulcanization accelerators such as 2-mercaptobenzothiazole and dibenzothiazyl disulfide (DM); and sulfenamide vulcanization accelerators such as N-cyclohexyl-2-benzothiazylsulfenamide and N-t-butyl-2-benzothiazylsulfenamide. An alkylphenol resin or its halide may also be employed.

Examples of the vulcanization retarder include organic acids such as phthalic anhydride, benzoic acid, salicylic acid, and acetylsalicylic acid; nitroso compounds such as N-nitroso-diphenylamine, N-nitroso-phenyl-β-naphthylamine, and a polymer of N-nitroso-trimethyl-dihydroquinoline; halides such as trichloromelanine; 2-mercaptobenzimidazole; and N-(cyclohexylthio)phthalimide (SANTOGARD PVI).

The content of such vulcanizing agent is preferably 0.1 to 20 parts by weight and more preferably 1 to 10 parts by weight with respect to 100 parts by weight of the thermoplastic elastomer of the present invention.

The method of producing the composition of the present invention is not particularly limited. For example, the thermoplastic elastomer of the present invention may be mixed with optional various additives in a roll mill, kneader, extruder, or universal blender to produce the composition.

The vulcanization conditions used when the composition of the present invention is permanently crosslinked (by using a vulcanizing agent) are not particularly limited, and an adequate set of conditions may be selected depending on the components incorporated in the composition, and the like. A preferable vulcanization condition is carrying out vulcanization at a temperature of 130 to 200° C. for 5 to 60 minutes.

When the thermoplastic elastomer (composition) of the present invention is heated to a temperature of about 80 to 200° C., the three-dimensional crosslink (crosslink structure) will become dissociated and the thermoplastic elastomer will gain some softness and fluidity presumably because of weakening of the intermolecular or intramolecular interaction between the side chains.

When the thermoplastic elastomer (composition) of the present invention that has become softer and more fluid is left to stand at a temperature of about 80° C. or lower, the dissociated three-dimensional crosslink (crosslink structure) will regain its crosslink to vulcanize. The recyclability of the thermoplastic elastomer (composition) of the present invention is realized by the repetition of such steps.

The thermoplastic elastomer (composition) of the present invention can be used in a variety of rubber applications by taking advantage of, for example, the rubber elasticity. Use as a hot melt adhesive or as an additive incorporated in such a hot melt adhesive is also preferable since the thermoplastic elastomer (composition) of the present invention is capable of improving the heat resistance and recyclability. The thermoplastic elastomer (composition) of the present invention is well adapted for use in automobile applications, hoses, belts, sheets, vibration isolating rubbers, rollers, linings, rubber-coated cloths, sealants, gloves, fenders, medical rubbers (syringe gaskets, tubes, and catheters), gaskets (for use in home appliances and construction materials), asphalt modifiers, hot melt adhesives, boots, grip members, toys, shoes, sandals, key pads, gears, cap linings of PET bottles, and the like.

Exemplary automobile applications include tread, carcass, side wall, inner liner, undertread, belt, and other parts of tire; radiator grille, side molding, garnish (pillar, rear, and top of cowl), aero parts (air dam and spoiler), wheel cover, weather strip, cowbelt grille, air outlet louver, air scoop, hood bulge, parts of ventilation opening, barrier parts (overfender, side seal panel, molding (window, hood, and door belt), and marks in the exterior; weather strip of doors, lights, and wipers, glass run, glass run channel, and other parts of interior window frame; air duct hose, radiator hose, and brake, hose; crankshaft seal, valve stem seal, head cover gasket, A/T oil cooler hose, mission oil seal, P/S hose, P/S oil seal, and other parts of lubrication oil system; fuel hose, emission control hose, inlet filler hose, diaphragm and other parts of fuel system; engine mount, intank pump mount, and other vibration isolating parts; CVJ boots, rack and pinion boots, and other boots; A/C hose, A/C seal, and other parts of air conditioner; timing belt, auxiliary belt, and other belt members; and windshield sealer, vinyl plastisol sealer, anaerobic sealer, body sealer, spot weld sealer, and other sealers.

The thermoplastic elastomer (composition) of the present invention may also be incorporated as an anti-flow agent in a resin or rubber which would otherwise undergoes cold flow at room temperature to thereby prevent flow upon extrusion and cold flow.

The thermoplastic elastomer (composition) of the present invention exhibits higher mechanical strength while retaining equivalent recyclability compared to conventional thermoplastic elastomers. Accordingly, of those applications mentioned above, the thermoplastic elastomer (composition) is adapted for use in applications that particularly require the recyclability and the mechanical strength.

### EXAMPLES

Next, the present invention is described in further detail by referring to the Examples, which by no means limit the scope of the present invention.

### Examples 1 to 7 and Comparative Example 1

First, to a kneader set to 180° C. were added N-n-octylaminoethanol (NYMEEN C-201 manufactured by NOF CORPORATION), polyethyleneimine (EPOMIN SP-018 with an M_{w} of 1,800 manufactured by Nippon Shokubai Co., Ltd.), polyethyleneimine (EPOMIN SP-200 with an M_{w} of 10,000 manufactured by Nippon Shokubai Co., Ltd.) and polyethylene glycol glyceryl ether (UNIOX G-450 manufactured by NOF CORPORATION) in amounts (unit: g) shown in Table 1 (equivalent ratio to the maleic anhydride skeleton is shown in parentheses) with respect to 100 g of maleic anhydride-modified ethylene-propylene copolymer (sample; maleic anhydride skeleton; 10.2 mmol) and 100 g of a flexible polyolefin resin (M142E manufactured by Idemitsu Kosan Co., Ltd.). The mixtures were heated with stirring in the kneader at 170° C. for 30 to 35 minutes to prepare thermoplastic elastomer compositions containing the thermoplastic elastomers.

The respective thermoplastic elastomer compositions obtained in Examples 1 to 7 and Comparative Example 1 were measured for their JIS-A hardness, tensile properties and compression set and evaluated for their recyclability. The results are shown in Table 1.

### JIS-A Hardness

Each thermoplastic elastomer composition obtained was hot pressed at 200° C. for 10 minutes to produce sheet samples having a thickness of 2 mm, length of 15 cm, and width of 15 cm. Five of the resulting sheet samples were placed on top of one another, and the laminate was hot pressed at 200° C. for 20 minutes, and evaluated for the JIS-A hardness according to JIS K6253.

### Tensile Properties

Each thermoplastic elastomer composition obtained was pressed at 180° C. for 10 minutes to produce a sheet with a thickness of 2 mm.

No. 3 dumbbell test pieces were blanked out of this sheet, and tensile test was conducted according to JIS K6251 at a tensile rate of 500 mm/min to thereby measure 100% modulus (M₁₀₀) [MPa], breaking strength (T_{B}) [MPa], and elongation at break (E_{S}) [%] at room temperature.

### Compression Set (C-Set)

Each thermoplastic elastomer composition obtained was hot-pressed at 180° C. for 10 minutes to prepare sheets with a thickness of 2 mm.

7 sheets were stacked on top of one another and pressed at 200° C. for 20 minutes to produce a cylindrical sample with the size of 29 mm (diameter)×12.5 mm (thickness).

The cylindrical sample was compressed by 25% with a purpose-built jig and left to stand at 70° C. for 22 hours. The compression set was then measured according to JIS K6262. The measurements were given in relation to the compression set in Comparative Example 1 that was regarded as 100%.

### Recyclability

Each thermoplastic elastomer composition obtained was hot-pressed at 200° C. for 10 minutes to prepare a sheet with a thickness of 2 mm. The sheet was then cut into fine pieces and pressed again. The recyclability of the composition was evaluated by the number of pressing operations each of which could provide an integral seamless sheet.

When the integral seamless sheet could be produced 10 or more times, the recyclability was rated as “good”.

TABLE 1

| | Comparative | | | | | | | |
|---|---|---|---|---|---|---|---|---|
| | Example | Example | | | | | | |
| | 1 | 1 | 2 | 3 | 4 | 5 | 6 | 7 |
| sample | 100 | 100 | 100 | 100 | 100 | 100 | 100 | 100 |
| M142E | 100 | 100 | 100 | 100 | 100 | 100 | 100 | 100 |
| NYMEEN C-201 | 2.82 | | | | | | | |
| | (1.0) | | | | | | | |
| EPOMIN SP-018 | | 0.42 | 0.84 | 1.68 | | | | |
| | | (0.5) | (1.0) | (2.0) | | | | |
| EPOMIN SP-200 | | | | | 0.44 | 0.88 | 1.77 | 0.66 |
| | | | | | (0.5) | (1.0) | (2.0) | (0.75) |
| UNIOX G-450 | | | | | | | | 0.64 |
| | | | | | | | | (0.25) |
| JIS-A | 57 | 57 | 57 | 58 | 58 | 58 | 56 | 58 |
| hardness | | | | | | | | |
| Tensile | | | | | | | | |
| properties | | | | | | | | |
| M₁₀₀ (MPa) | 1.2 | 1.2 | 1.3 | 1.2 | 1.2 | 1.2 | 1.3 | 1.5 |
| T_{B} (MPa) | 4.0 | 4.1 | 4.1 | 2.8 | 3.6 | 3.8 | 2.7 | 5.1 |
| E_{B} (%) | 520 | 544 | 411 | 322 | 548 | 399 | 346 | 465 |
| Compression | 100 | 83 | 50 | 59 | 91 | 20 | 50 | 52 |
| set | | | | | | | | |
| (indicated by | | | | | | | | |
| percentage) | | | | | | | | |
| Recyclability | Good | Good | Good | Good | Good | Good | Good | Good |

The results shown in Table 1 revealed that the thermoplastic elastomer compositions prepared in Examples 1 to 7 exhibited excellent mechanical strength and in particular excellent resistance to compression set while retaining the excellent recyclability compared to the thermoplastic elastomer composition prepared by reacting the elastomeric polymers with the polyamine compound having only one primary amino group in Comparative Example 1.

### Examples 8 and 9

First, to the kneader set to 180° C. were added a hydroxy group-containing polyamine compound 1 or 2 synthesized by the method to be described below in amounts (unit: g) shown in Table 2 (equivalent ratio to the maleic anhydride skeleton is shown in parentheses) with respect to 100 g of maleic anhydride-modified ethylene-propylene copolymer (sample; maleic anhydride skeleton: 10.2 mmol) and 100 g of a flexible polyolefin resin (M142E manufactured by Idemitsu Kosan Co., Ltd.). The mixtures were heated with stirring in the kneader at 180° C. for 20 minutes to prepare thermoplastic elastomer compositions containing the thermoplastic elastomers.

### Examples 10 to 15

First, to the kneader set to 180° C. were added the hydroxy group-containing polyamine compound 1 or 2 synthesized by the method to be described below in amounts (unit: g) shown in Table 2 (equivalent ratio to the maleic anhydride skeleton is shown in parentheses) with respect to 100 g of maleic anhydride-modified ethylene-propylene copolymer (sample; maleic anhydride skeleton: 10.2 mmol) and 100 g of a flexible polyolefin resin (M142E manufactured by Idemitsu Kosan Co., Ltd.), 100 g of paraffin oil (PW-90 manufactured by Idemitsu Kosan Co., Ltd.), and 50 g of a styrene-ethylene-ethylene-propylene-styrene block copolymer (SEPTON 4077 manufactured by Kuraray Co., Ltd.; styrene content: 30 wt %). The mixtures were heated with stirring in the kneader at 180° C. for 20 minutes to prepare thermoplastic elastomer compositions containing the thermoplastic elastomers.

The hydroxy group-containing polyamine compound 1 used was the one (hydroxy value: 420; total amine value; 911; tertiary amine value: 749; molecular weight: 825) obtained by blocking 40% of the primary and secondary amino groups in a polyethyleneimine (EPOMIN SP-018 with an M_{w} of 1,800 manufactured by Nippon Shokubai Co., Ltd.) with ethylene oxide.

The hydroxy group-containing polyamine compound 2 used was the one (hydroxy value: 510; total amine value: 719; tertiary amine value: 537; molecular weight: 915) obtained by blocking 70% of the primary and secondary amino groups in the polyethyleneimine (EPOMIN SP-018 with an M_{w} of 1,800 manufactured by Nippon Shokubai Co., Ltd.) with ethylene, oxide in the same manner.

It was confirmed from the total amine value, tertiary amine value and molecular weight that the hydroxy group-containing polyamine compounds 1 and 2 each have two or more primary amino groups.

According to the methods described above, the respective thermoplastic elastomer compositions obtained in Examples 8 to 15 were measured for their JIS-A hardness, tensile properties and compression set and evaluated for their recyclability. The results are shown in Table 2.

The respective thermoplastic elastomer compositions obtained in Examples 8 to 15 were also evaluated for their sheet formability, extrusion moldability and odor by the methods described below. The results are shown in Table 2.

### Sheet Formability

Each thermoplastic elastomer composition obtained was hot-pressed at 180° C. for 10 minutes to prepare a sheet with a thickness of 2 mm.

The surface of the prepared sheet was visually observed. As a result, every sheet was found to have a smooth surface and be excellent in sheet formability, and was therefore rated as “good”.

### Extrusion Moldability

The capillary viscosity at 230° C. of each thermoplastic elastomer composition obtained was measured according to JIS K7199:1999 and the surface texture of the strand extruded from a capillary viscometer during the viscosity measurement was visually observed.

As a result of the visual observation of the surface texture of the strand, every thermoplastic elastomer composition was found to achieve excellent extrusion moldability while the strand had a smooth surface texture, and was therefore rated as “good”.

### Odor

Each thermoplastic elastomer composition obtained was hot-pressed at 180° C. for 10 minutes to prepare a sheet with a thickness of 2 mm.

The prepared sheet was rated as “good” when it was found to have little order compared to the sheets in Examples 1 to 7 in which polyethyleneimine was used as the polyamine compound.

TABLE 2

| | Example | | | | | | | |
|---|---|---|---|---|---|---|---|---|
| | 8 | 9 | 10 | 11 | 12 | 13 | 14 | 15 |
| sample | 100 | 100 | 100 | 100 | 100 | 100 | 100 | 100 |
| M142E | 100 | 100 | 100 | 100 | 100 | 100 | 100 | 100 |
| Paraffin oil | | | 100 | 100 | 100 | 100 | 100 | 100 |
| SEPTON 4077 | | | 50 | 50 | 50 | 50 | 50 | 50 |
| Hydroxy group- | 3.15 | | 1.57 | 3.15 | 4.71 | | | |
| containing polyamine | (2.0) | | (1.0) | (2.0) | (3.0) | | | |
| compound 1 | | | | | | | | |
| Hydroxy group- | | 2.65 | | | | 1.32 | 2.65 | 3.96 |
| containing polyamine | | (2.0) | | | | (1.0) | (2.0) | (3.0) |
| compound 2 | | | | | | | | |
| JIS-A hardness | 70 | 69 | 55 | 58 | 56 | 56 | 57 | 56 |
| Tensile properties | | | | | | | | |
| M₁₀₀ (MPa) | 2.1 | 2.1 | 1.4 | 1.2 | 1.1 | 1.1 | 1.2 | 1.1 |
| T_{B} (MPa) | 4.8 | 5.2 | 4.6 | 4.1 | 3.7 | 5.4 | 4.8 | 4.5 |
| E_{B} (%) | 350 | 410 | 389 | 454 | 552 | 548 | 510 | 525 |
| Compression set | 46 | 58 | 30 | 22 | 21 | 44 | 34 | 32 |
| (indicated by | | | | | | | | |
| percentage) | | | | | | | | |
| Recyclability | Good | Good | Good | Good | Good | Good | Good | Good |
| Sheet formability | Good | Good | Good | Good | Good | Good | Good | Good |
| Extrusion | Good | Good | Good | Good | Good | Good | Good | Good |
| moldability | | | | | | | | |
| Odor | Good | Good | Good | Good | Good | Good | Good | Good |

The results shown in Table 2 revealed that, as in Examples 1 to 7, the thermoplastic elastomer compositions prepared in Examples 8 to 15 exhibited excellent mechanical strength and in particular excellent resistance to compression set while retaining the excellent recyclability. It was also revealed that the thermoplastic elastomer compositions prepared in Examples 8 to 15 could have reduced odor while achieving excellent sheet formability and extrusion moldability.

What is claimed is:

1. A thermoplastic elastomer obtained by reacting an elastomeric polymer containing a cyclic acid anhydride group in its side chain and a polyamine compound having two or more primary amino groups.

2. The thermoplastic elastomer according to claim 1, wherein the polyamine compound has secondary amino group.

3. The thermoplastic elastomer according to claim 2, wherein the polyamine compound is a polyalkyleneimine.

4. The thermoplastic elastomer according to claim 1, wherein the polyamine compound has branched carbon and/or branched nitrogen.

5. The thermoplastic elastomer according to claim 4, wherein the polyamine compound has tertiary amino group.

6. The thermoplastic elastomer according to claim 1, wherein the polyamine compound also has two or more hydroxy groups.

7. The thermoplastic elastomer according to claim 1 which has a structure represented by the following formula (1): 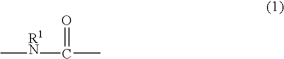
wherein R¹ is a hydrogen atom or a hydrocarbon group which may contain at least one heteroatom selected from the group consisting of O, N and S.

8. The thermoplastic elastomer according to claim 7 which has a structure represented by the following formula (2): 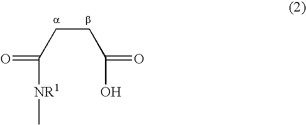
wherein R¹ is a hydrogen atom or a hydrocarbon group which may contain at least one heteroatom selected from the group consisting of O, N and S, the structure being attached to its main chain at α or β position.

9. The thermoplastic elastomer according to claim 1 which is formed by reacting the elastomeric polymer with the polyamine compound and a polyol compound.

10. The thermoplastic elastomer according to claim 9, wherein the polyol compound is a polyether polyol.

11. The thermoplastic elastomer according to claim 9 which has a structure represented by the following formula (3):

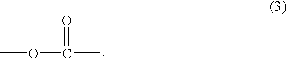

12. The thermoplastic elastomer according to claim 11 which has a structure represented by the following formula (4): 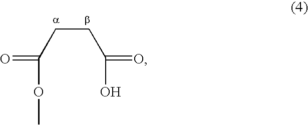
the structure being attached to its main chain at α or β position.

13. A thermoplastic elastomer composition containing the thermoplastic elastomer according to claim 1.
